(19) United States
(12) Patent Application Publication
(10) Pub. No.: US 2026/0046639 A1
(43) Pub. Date: Feb. 12, 2026

(54) OPEN RADIO ACCESS NETWORK DESIGN AUDITING SYSTEM

(71) Applicant: Dish Wireless L.L.C., Englewood, CO (US)

(72) Inventors: Ahmed Awwad Whdan, Centennial, CO (US); Karupaiah Rajendran, Sachse, TX (US)

(21) Appl. No.: 18/800,450

(22) Filed: Aug. 12, 2024

(51) Int. Cl. H04W 16/18; H04B 17/309; H04B 17/318; H04W 64/00

(52) U.S. Cl. CPC H04W 16/18; H04B 17/328; H04B 17/346; H04W 64/003

(57) ABSTRACT

A computing system receives a selection of a design parameter to be verified that is associated with deployment of a new radio access network (RAN) site. The computing system retrieves a design value of the design parameter from a design data store and one or more threshold values from design guidelines that constrain the design parameter according to site design rules. In response to the design value not satisfying the one or more threshold values, the computing system determines, based on data associated with other RAN site deployments in an area of interest (AOI) that includes a proposed location for the new RAN site, an updated design value that satisfies the one or more threshold values; and replaces, in the design data store, the design value with the updated design value.

### BACKGROUND

One type of cellular network is a Fifth generation (5G) wireless network. In a 5G wireless network, a 5G Core Network (5G core) is responsible for managing and routing data traffic, providing various network resources and services, and supporting the core functionalities of a 5G network. Fifth generation (5G) wireless networks have the promise to provide higher throughput, lower latency, and higher availability compared with previous global wireless standards.

Open radio access network (RAN) is an initiative aimed at standardizing and promoting the interoperability of various equipment and software components from different vendors that are used in the RAN of mobile networks. In this way, open RAN seeks to create a more flexible and vendor-neutral ecosystem, enabling operators to mix and match products from different vendors, leading to increased competition, innovation, and cost efficiency.

An area of interest (AOI) can be understood to be a geographic region or area that is being audited for various design parameters and performance metrics, also referred to as key performance indicators (KPIs) that are of interest in a cellular design audit. Because some components of a 5G network are networked across the Internet or cloud, deciding on a location of an open RAN site can be non-trivial and carry a number of challenging considerations. For example, many different engineers may design and configure RAN sites across each AOI where any given operator may operate thousands of RAN sites across a region or country. Because of the high number of sites and the potentially hundreds of design parameters and considerations, RAN site designs (whether new or existing) can incur engineering errors that, at best, break some preferred design rules, and at worst, cause a significant decrease in KPIs.

### BRIEF DESCRIPTION OF THE DRAWINGS

The present disclosure is illustrated by way of example, and not by way of limitation, in the figures of the accompanying drawings.

FIG. 1A is an example 5G network including a radio access network (RAN), which can be configured or updated by a site design audit system according to at least one embodiment.

FIG. 1B is an example a 5G network, which includes a core network for providing a communications channel (or channel) between user equipment and a data network, as well as the site design audit system according to various embodiments.

FIG. 1C is an example site design audit system that will be discussed in detail herein according to some embodiments.

FIG. 2 is a simplified design map of neighboring areas of interest (AOI) that illustrates some of the design parameters for auditing multiple open RAN sites according to various embodiments.

FIG. 3A is a flow diagram of a method of auditing a new RAN site design according to at least some embodiments.

FIG. 3B is a flow diagram of a method of auditing existing RAN site designs according to at least some embodiments.

FIG. 4A, FIG. 4B, and FIG. 4C are flow diagrams of methods for verifying a location for an open RAN site based on design rules associated with AOI, RAN component distances, and clutter types according to various embodiments.

FIG. 5A, FIG. 5B, FIG. 5C are flow diagrams of methods for verifying a location for an open RAN site based on design rules associated with inter-site distance (ISD), morphology, clutter height compared to structure type, and antenna height compared to structure type according to various embodiments.

FIG. 6A, FIG. 6B, FIG. 6C, FIG. 6D are flow diagrams of methods for verifying M-tilt and E-tilt of antennas, antenna type, frequency band, number of transmitters, and azimuths of antennas for each transmitter according to some embodiments.

FIG. 7A is a flow diagram of a method for verifying reserve signal receive power (RSRP), signal-to-interference noise ratio (SINR), and throughput target values associated with key performance indicators for particular hotspots according to some embodiments.

FIG. 7B is a flow diagram of a method for verifying site location relative to hotspot(s) and population coverage based on KPIs and morphology according to some embodiments.

FIG. 8 illustrates a block diagram illustrating an exemplary computer device, in accordance with implementations of the present disclosure.

### DETAILED DESCRIPTION

Technologies for auditing open RAN sites are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, due to the high number of cellular (RAN) sites and the potentially hundreds of design parameters (or operands) and considerations, RAN site designs (whether new or existing) can incur engineering errors that, at best, break some preferred design rules, and at worst, cause a significant decrease in KPIs. Although some design errors are expected, too many design errors can cause significant impacts on efficiency and increase costs in deploying and maintaining a 5G (or 6G) network that continues to expand to cover more and more area. These challenges are uniquely technical in nature since engineers design sites using simulations and computing systems, but typically only for a particular site within a particular AOI. Thus, individual RAN sites may be designed with a confined perspective and without consideration of other nearby sites or considerations that can only be provided with a higher-level audit of an AOI or a region of multiple AOIs.

Aspects and embodiments of the present disclosure address the above and other deficiencies by performing audits on designs for new RAN sites as well as performing ongoing audits on existing RAN sites for continued compliance with particular site design rules or guidelines, as will be explained. In some embodiments, a computing system that includes one or more processing devices performs the audit and be configured to connect to particular memory, storage, databases, open source servers or sources of data, and the like, and employ both public and private data in determining whether particular site designs comply with various constraints or design rules. If the computing system determines that a particular design value of a design parameter is incorrect, e.g., does not satisfy one or more threshold values based on design guidelines or rules, then the computing system can analyze the design parameter with more information and from a higher-level, taking into account other existing RAN sites.

For example, a design data store can include one or more data structures in which design values are stored that characterize the RAN site design for many different RAN sites, including proposed new sites. The computing system can then update the design value(s) in a way that resolves the detected error and streamlines the process by which contractors are deployed to build a new RAN site or maintenance teams are deployed to alter an existing RAN site such that the RAN sites comply with design guidelines and rules. In this way, new and existing designs are optimized in coverage, cost effectiveness, and design efficiency. In some embodiments, the RAN site design primarily refers to parameters, operands, and design considerations of a 5G base station that includes a radio unit (RU), transceiver(s), and antenna(s), and thus hardware components that communicate with user equipment (UE) or other mobile devices that connect through the 5G network. However, at least some design parameters or operands make reference to where and how to locate other components of a RAN site such as distributed units (DUs) and centralized unit (CUs).

In some embodiments, the computing system receives a selection of a design parameter to be verified that is associated with deployment of a new radio access network (RAN) site. The computing system may retrieve a design value of the design parameter from a design data store and one or more threshold values from design guidelines that constrain the design parameter according to site design rules. In response to the design value not satisfying the one or more threshold values, the computing system can determine, based on data associated with other RAN site deployments in an AOI that includes a proposed location for the new RAN site, an updated design value that satisfies the one or more threshold values. The computing system can then replace, in the design data store, the design value with the updated design value. The computing system can optionally also electronically issues a work order or instructions to a site deployment team that incorporates a plurality of design values, including the updated design value, stored in the design data store.

In other embodiments, the computing system selects a design parameter to be verified that is associated with existing deployments of a plurality of new radio access network (RAN) sites The computing system may retrieve design values of the design parameter from a design data store and one or more threshold values from design guidelines that constrain the design parameter according to site design rules. In response to a design value not satisfying the one or more threshold values for a particular RAN site of the plurality of RAN sites, the computing system can determine an updated design value that satisfies the one or more threshold values based on first data associated with RAN site deployments in an AOI of the plurality of RAN sites. The computing system can then replace the design value in the design data store with the updated design value. The computing system can optionally also, in response to a design value not satisfying the one or more threshold values for a particular RAN site of the plurality of RAN sites, electronically issue a work order or instructions to a maintenance team to update a configuration of the particular RAN site based on the updated design value.

Therefore, advantages of the systems and methods implemented in accordance with some embodiments of the present disclosure include providing a centralized and powerful way to audit open RAN sites that are proposed and now exist for compliance with design guidelines and rules. If an error is detected in an audit, the design parameter for which the error is detected can be analyzed and its corresponding one or more design values updated to resolve the error. In this way, the disclosed systems and methods can determine a change in the design value that will comply with the design guidelines and/or rules, and make the particular change in the design value. Further, new and existing RAN site designs are optimized in coverage, cost effectiveness, and design efficiency. Additional advantages that would be apparent to those skilled in the art of open RAN or other cellular site auditing will be discussed below in more detail with reference to the described Figures.

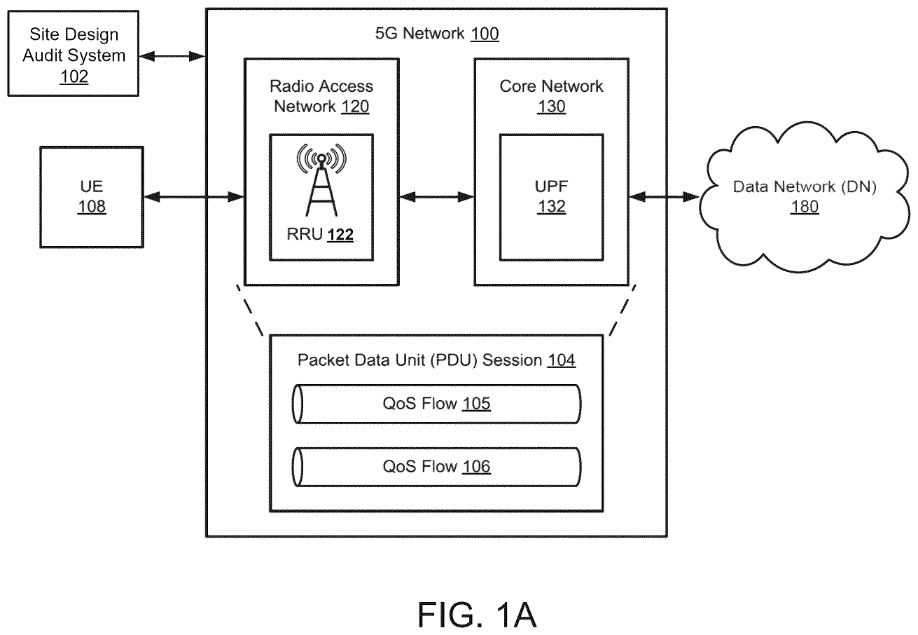

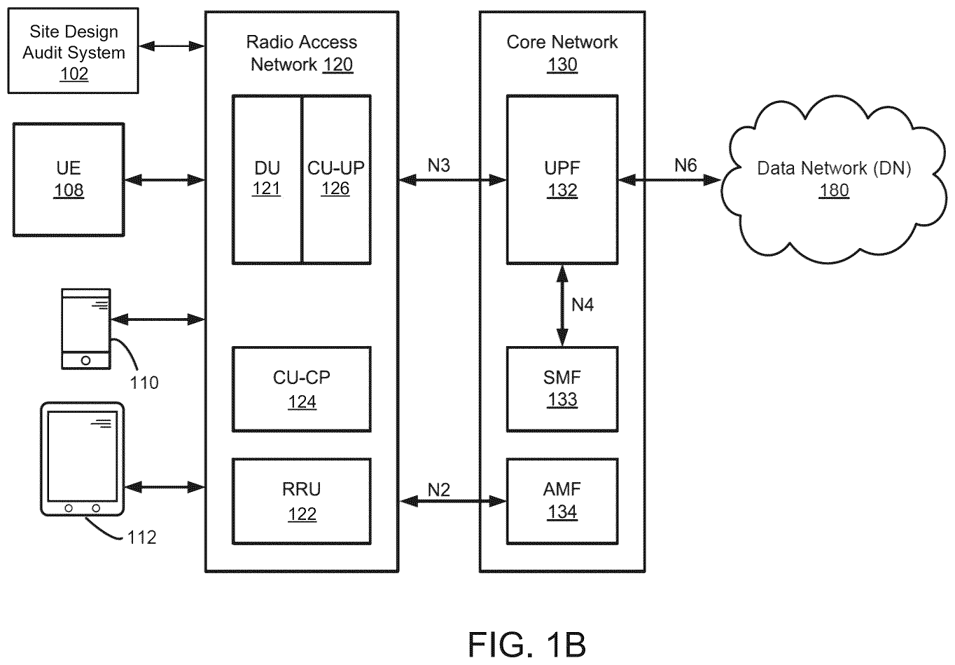

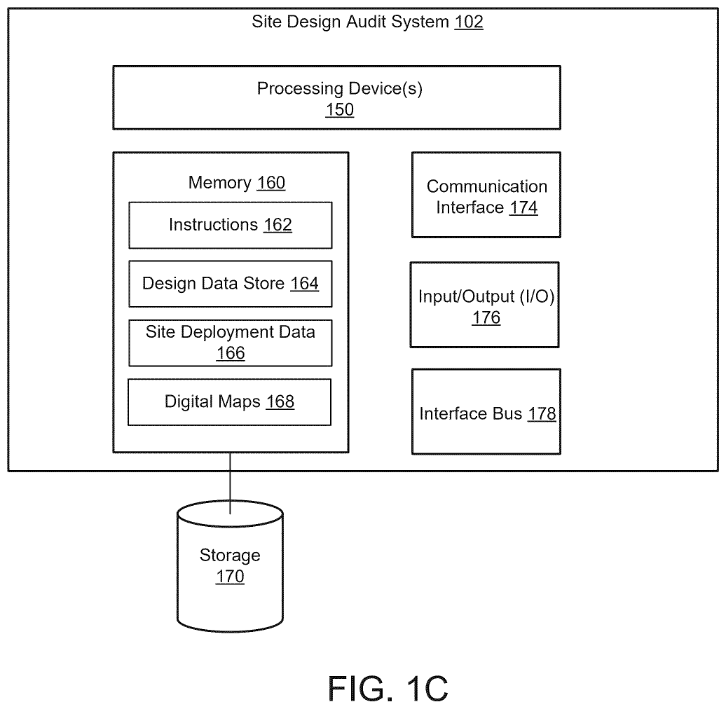

FIG. 1A is an example 5G network 100 including a radio access network (RAN) 120, which can be configured or updated by a site design audit system 102 according to at least one embodiment. The site design audit system 102 will be discussed in more detail with reference to FIG. 1C, but it should be understood that the discussion of the RAN 120 is simplified by generally explaining the RAN 120 of a single site, whereas the site design audit system 102 will analyze and audit the deployment and designs of multiple RAN sites.

In some embodiments, the 5G network also includes a core network 130 coupled to a data network (DN) 180. The RAN 120 can include a new-generation radio access network (NG-RAN) that uses the 5G/6G new radio interface (NR). The 5G network 100 connects user equipment (UE) 108 to the data network (DN) 180 using the RAN 120 and the core network 130. The data network 180 can include the Internet, a local area network (LAN), a wide area network (WAN), a private data network, a wireless network, a wired network, or a combination of networks. The UE 108 can include an electronic device with wireless connectivity or cellular communication capability, such as a mobile phone 110 or handheld computing device 112. In at least one example, the UE 108 can include a 5G smartphone or a 5G cellular device that connects to the RAN 120 via a wireless connection. The UE 108 can include one of a number of UEs not depicted that are in communication with the RAN 120. The UEs may include mobile and non-mobile computing devices. The UEs may include laptop computers, desktop computers, an Internet-of-Things (IoT) devices, and/or any other electronic computing device that includes a wireless communications interface to access the RAN 120.

The RAN 120 includes a remote radio unit (RRU) 122 at each RAN site for wirelessly communicating with UE 108. The remote radio unit (RRU) 122 can include a Radio Unit (RU) at each RAN site and may include one or more radio transceivers (e.g., combined receiver and transmitter) for wirelessly communicating with UE 108. The remote radio unit (RRU) 122 may include circuitry for converting signals sent to and from an antenna of a Base Station into digital signals for transmission over packet networks. The RAN 120 may correspond with a 5G radio Base Station that connects user equipment to the core network 130. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 108.

The core network 130 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The primary core network functions can include the access and mobility management function (AMF), the session management function (SMF), and a user plane function (UPF), all of which may provide user session capability and user data. The UPF (e.g., UPF 132) may perform packet processing including routing and forwarding, quality of service (QoS) handling, and packet data unit (PDU) session management. The UPF 132 may serve as an ingress and egress point for user plane traffic and provide anchored mobility support for user equipment. For example, the UPF 132 may provide an anchor point between the UE 108 and the data network 180 as the UE 108 moves between coverage areas. The AMF may act as a single-entry point for an UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 120, such as a Distributed Unit (DU) and a centralized unit (CU), may need to be deployed at a cell site or in a local data center (LDC) that is in close proximity to a cell site such that the latency requirements are satisfied (e.g., such that the one-way latency from the cell site to the DU component or CU component is less than ˜1.2 milliseconds (ms)).

In some embodiments, the Distributed Unit (DU) and the centralized unit (CU) of the RAN 120 may be co-located with the remote radio unit (RRU) 122. In other embodiments, the Distributed Unit (DU) and the remote radio unit (RRU) 122 may be co-located at a cell site and the centralized unit (CU) may be located within a local data center (LDC).

The 5G network 100 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 100. In some cases, the 5G network 100 may support customized policy configuration and enforcement between network slices per service level agreements (SLAs) within the radio access network (RAN) 120. User equipment, such as UE 108, may connect to multiple network slices at the same time (e.g., eight different network slices). In one embodiment, a PDU session, such as PDU session 104, may belong to only one network slice instance. In some cases, the 5G network 100 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 130 may include a set of network elements that are configured to offer various data and telecommunications services to subscribers or end users of user equipment, such as UE 108. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 100 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 1A, the core network 130 includes a user plane function (UPF) 132 for transporting IP data traffic (e.g., user plane traffic) between the UE 108 and the data network 180 and for handling packet data unit (PDU) sessions with the data network 180. The UPF 132 can include an anchor point between the UE 108 and the data network 180. The UPF 132 may be implemented as a software process or application running within a virtualized infrastructure or a cloud-based compute and storage infrastructure. The 5G network 100 may connect the UE 108 to the data network 180 using a PDU session 104, which can include part of an overlay network.

The PDU session 104 may utilize one or more quality of service (QoS) flows, such as QoS flows 105 and 106, to exchange traffic (e.g., data and voice traffic) between the UE 108 and the data network 180. The one or more QoS flows can include the finest granularity of QoS differentiation within the PDU session 104. The PDU session 104 may belong to a network slice instance through the 5G network 100. To establish user plane connectivity from the UE 108 to the data network 180, an AMF that supports the network slice instance may be selected and a PDU session via the network slice instance may be established. In some cases, the PDU session 104 may be of type IPv4 or IPv6 for transporting IP packets. The RAN 120 may be configured to establish and release parts of the PDU session 104 that cross the radio interface.

The RAN 120 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 108, over a geographic area. Some cells may correspond with stationary coverage areas and other cells may correspond with coverage areas that change over time (e.g., due to movement of a mobile RRU).

In some cases, the UE 108 may be capable of transmitting signals to and receiving signals from one or more RRUs within the network of cells over time. One or more cells may correspond with a cell site. The cells within the network of cells may be configured to facilitate communication between UE 108 and other UEs and/or between UE 108 and a data network, such as data network 180. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

Referring to FIG. 1A, the UPF 132 may be responsible for routing and forwarding user plane packets between the RAN 120 and the data network 180. Uplink packets arriving from the RAN 120 may use a general packet radio service (GPRS) tunneling protocol (or GTP) to reach the UPF 132. The GPRS tunneling protocol for the user plane may support multiplexing of traffic from different PDU sessions by tunneling user data over the interface between the RAN 120 and the UPF 132.

The UPF 132 may remove the packet headers belonging to the GTP tunnel before forwarding the user plane packets towards the data network 180. As the UPF 132 may provide connectivity towards other data networks in addition to the data network 180, the UPF 132 must ensure that the user plane packets are forwarded towards the correct data network. Each GTP tunnel may belong to a specific PDU session, such as PDU session 104. Each PDU session may be set up towards a specific data network name (DNN) that uniquely identifies the data network to which the user plane packets should be forwarded. The UPF 132 may keep a record of the mapping between the GTP tunnel, the PDU session, and the DNN for the data network to which the user plane packets are directed.

Downlink packets arriving from the data network 180 are mapped onto a specific QoS flow belonging to a specific PDU session before forwarded towards the appropriate RAN 120. A QoS flow may correspond with a stream of data packets that have equal quality of service (QoS). A PDU session may have multiple QoS flows, such as the QoS flows 105 and 106 that belong to PDU session 104. The UPF 132 may use a set of service data flow (SDF) templates to map each downlink packet onto a specific QoS flow. The UPF 132 may receive the set of SDF templates from a session management function (SMF), such as the SMF 133 depicted in FIG. 1B, during setup of the PDU session 104. The UPF 132 may track various statistics regarding the volume of data transferred by each PDU session, such as PDU session 104, and provide the information to an SMF.

FIG. 1B is an example 5G network 100, which includes the a core network 130 for providing a communications channel (or channel) between user equipment and data network 180, as well as the site design audit system 102, according to various embodiments, which will be discussed in more detail with reference to FIG. 1C. The communications channel can include a pathway through which data is communicated between the UE 108 and the data network 180. The user equipment in communication with the RAN 120 includes UE 108, mobile phone 110, and mobile computing device 112. The user equipment may include a set of electronic devices, including mobile computing device and non-mobile computing device.

The core network 130 includes network functions such as an access and mobility management function (AMF) 134, a session management function (SMF) 133, and a user plane function (UPF) 132. The AMF may interface with user equipment and act as a single-entry point for a UE connection. The AMF may interface with the SMF to track user sessions, to include authenticating the UE 108, assigning the UE 108 an IP address, and creating a session for the UE 108. The AMF may interface with a network slice selection function (NSSF) (not depicted) to select network slice instances for user equipment, such as UE 108. When user equipment is leaving a first coverage area and entering a second coverage area, the AMF 134 may be responsible for coordinating the handoff between the coverage areas whether the coverage areas are associated with the same radio access network or different radio access networks. The SMF 133 may also manage security of the UE 108 and ensure that user data is protected.

The UPF 132 may transfer downlink data received from the data network 180 to user equipment, such as UE 108, via the RAN 120 and/or transfer uplink data received from user equipment to the data network 180 via the RAN 120. An uplink can include a radio link though which user equipment transmits data and/or control signals to the RAN 120. A downlink can include a radio link through which the RAN 120 transmits data and/or control signals to the user equipment. The UPF 132 may thus be responsible for functions such as packet routing, packet forwarding, and packet filtering.

The RAN 120 may be logically divided into a remote radio unit (RRU) 122, which can include a Radio Unit (RU), a Distributed Unit (DU) 121, and a centralized unit (CU) that is partitioned into a CU user plane portion (CU-UP) 126 and a CU control plane portion (CU-CP) 124. The CU-UP 126 may correspond with the centralized unit for the user plane and the CU-CP 124 may correspond with the centralized unit for the control plane. The CU-CP 124 may perform functions related to a control plane, such as connection setup, mobility, and security. The CU-UP 126 may perform functions related to a user plane, such as user data transmission and reception functions.

Decoupling control signaling in the control plane from user plane traffic in the user plane may allow the UPF 132 to be positioned in close proximity to the edge of a network compared with the AMF 134. As a closer geographic or topographic proximity may reduce the electrical distance, this means that the electrical distance from the UPF 132 to the UE 108 may be less than the electrical distance of the AMF 134 to the UE 108. The RAN 120 may be connected to the AMF 134, which may allocate temporary unique identifiers, determine tracking areas, and select appropriate policy control functions (PCFs) for user equipment, via an N2 interface. The N3 Interface may be used for transferring user data (e.g., user plane traffic) from the RAN 120 to the user plane function UPF 132 and may be used for providing low-latency services using edge computing resources. The electrical distance from the UPF 132 (e.g., located at the edge of a network) to user equipment, such as UE 108, may impact the latency and performance services provided to the user equipment. The UE 108 may be connected to the SMF 133 via an N1 interface not depicted, which may transfer UE information directly to the AMF 134. The UPF 132 may be connected to the data network 180 via an N6 interface. The N6 interface may be used for providing connectivity between the UPF 132 and other external or internal data networks (e.g., to the Internet). The RAN 120 may be connected to the SMF 133, which may manage UE context and network handovers between Base Stations, via the N2 interface. The N2 interface may be used for transferring control plane signaling between the RAN 120 and the AMF 134.

The RRU 122 may perform physical layer functions, such as employing orthogonal frequency-division multiplexing (OFDM) for downlink data transmission. In some cases, the DU 121 may be located at a cell site (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different cell sites (or cellular Base Stations) and 180 different RRUs.

In some embodiments, the RAN 120 or portions of the RAN 120 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 121 and CU-UP 126 may be executed as virtual instances within a data center environment that provides single-digit millisecond latencies (e.g., less than 2 ms) from the virtual instances to the UE 108.

In some cases, a data center may refer to a networked group of computing and storage devices that may run applications and services. The data center may include hardware servers, storage systems, routers, switches, firewalls, application-delivery controllers, cooling systems, and power subsystems. A data center may refer to a collection of computing and storage resources provided by on-premises physical servers and/or virtual networks that support applications and services across pools of physical infrastructure. Within a data center, a set of services may be connected together to provide a computing and storage resource pool upon which virtualized entities may be instantiated. Multiple data centers may be interconnected with each other to form larger networks consisting of pooled computing and storage resources connected to each other by connectivity resources. The connectivity resources may take the form of physical connections, such as Ethernet or optical communications links, and may include wireless communication channels as well. If two different data centers are connected by a set of different communication channels, the links may be combined together using various techniques including the formation of link aggregation groups (LAGs). A LAG can include a logical interface that uses the link aggregation control protocol (LACP) to aggregate multiple connections at a single direct connect endpoint.

One technical benefit of utilizing edge computing to move network functions closer to user equipment is that data communication latency may be reduced. The reduced latency may enable real-time interactivity between user equipment, such as UE 108 in FIG. 1A, and cloud-based services. Edge computing, including mobile edge computing, may refer to the arrangement of computing and associated storage resources at locations closer to the “edge” of a network in order to reduce data communication latency to and from user equipment (e.g., end user mobile phones). Some technical benefits of positioning edge computing resources closer to UEs include low latency data transmissions (e.g., under 5 ms), real-time (or near real-time) operations, reduced network backhaul traffic, and reduced energy consumption. The edge computing resources may be located within on-premises data centers (on-prem), near or on cell towers, and at network aggregation points within the radio access networks and core networks. Examples of applications and services that may be executed using edge computing include virtual network functions and 5G-enabled network services. The virtual network functions can include software-based network functions that are executed using the edge computing resources.

Technical benefits of dynamically assigning one or more virtualized network functions (e.g., a user plane function) to different locations or servers for execution within a data center hierarchy is that latency, power, and availability requirements may be optimized for multiple network slices over time. Technical benefits of adjusting the server location or the data center location of one or more virtualized network functions (e.g., a user plane function) for a network slice over time is that the network slice may be dynamically reconfigured to adapt to changes in latency, power, and availability requirements. In one example, a network slice may have a first configuration corresponding with a low-latency configuration in which a user plane function is deployed at a cell site and then subsequently be reconfigured to a second configuration corresponding with a low-power configuration in which the user plane function is redeployed at a breakout edge data center location.

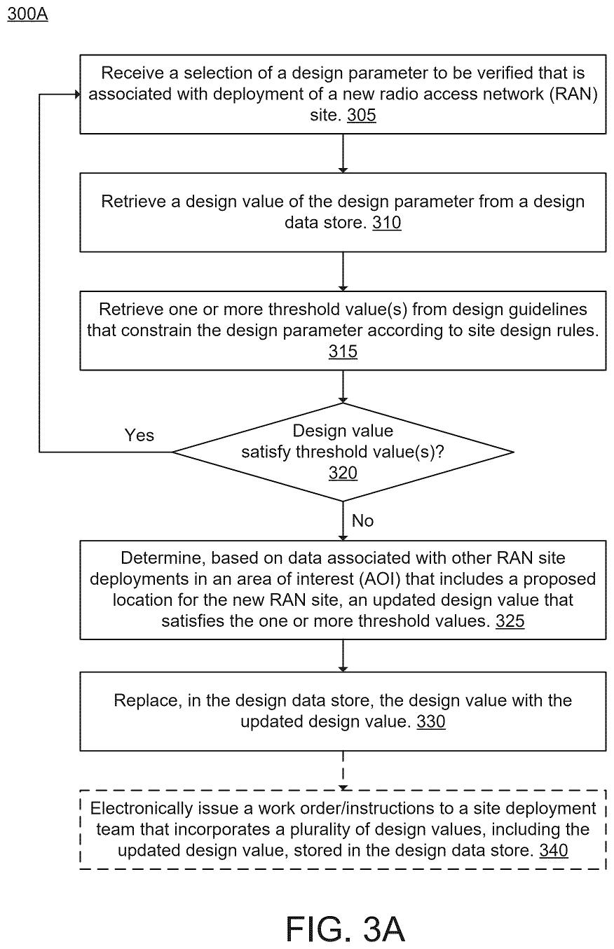

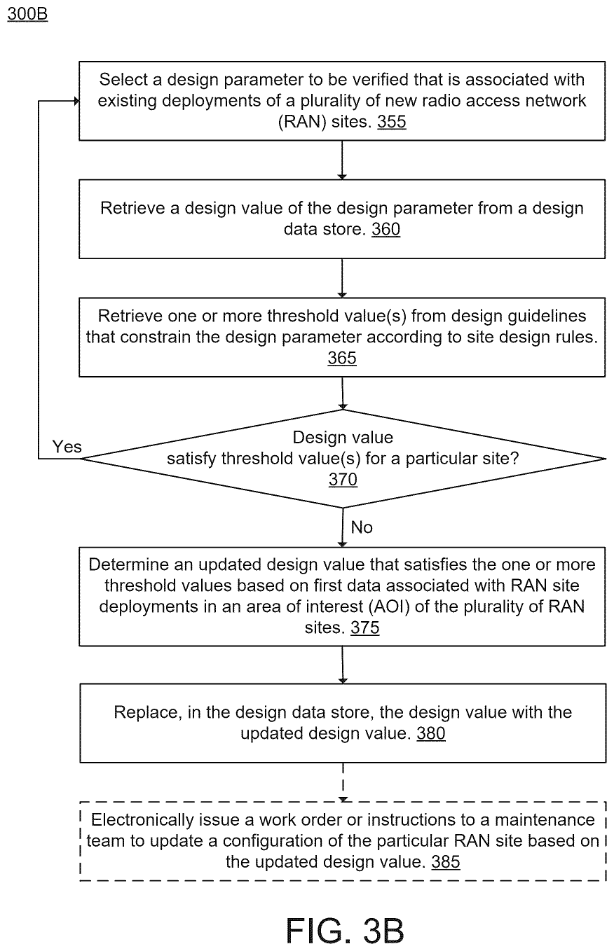

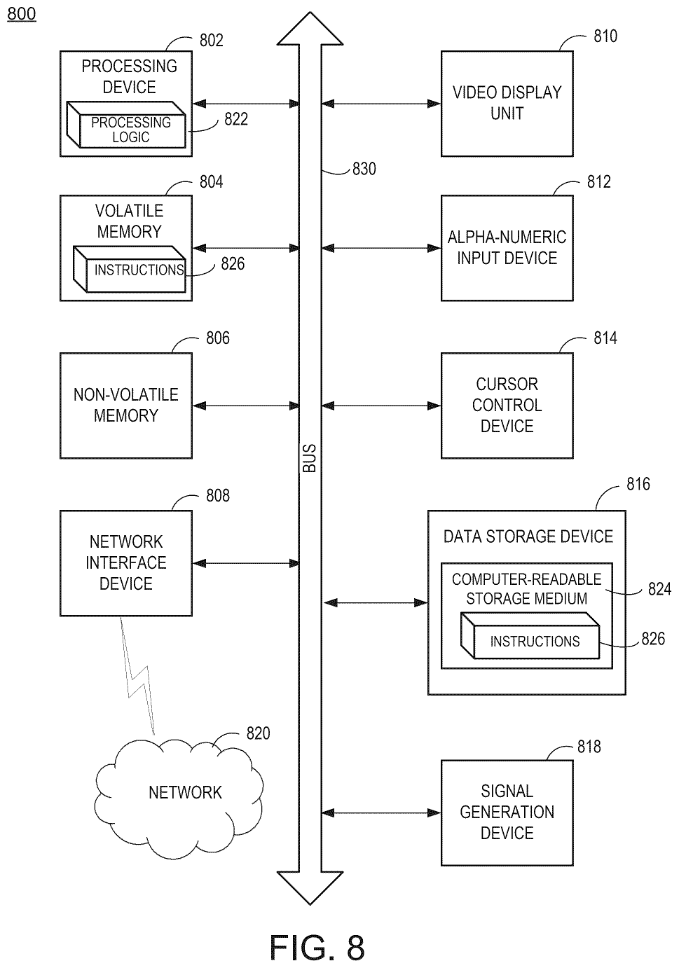

FIG. 1C is an example site design audit system 102 that will be discussed in detail herein according to some embodiments. In some embodiments, the site design audit system 102 includes one or more processing devices 150, and thus can be a distributed server or system, e.g., that can be implemented in the cloud or a cross a network. The site design audit system 102 can be a computer system (see FIG. 8) that includes memory 160 communicatively coupled with and readable by the one or more processing devices 150 and having stored therein processor-readable instructions 162 which, when executed by the one or more processing devices, cause the one or more processing devices to perform operations such as that implement the methods disclosed herein in FIG. 3A through FIG. 7B.

In various embodiments, the memory 160 includes the instructions 162, a design data store 164, site deployment data 166, and digital maps 168, among other data as might be described hereinafter. In embodiments, the site deployment data 166 can include data related to or associated with making decisions whether particular design values are correct. Further, the digital maps 168 can include a particular sub-set of such site deployment data 166 in providing topological-related information such as morphology type, structure type, clutter type, height information for different buildings or RAN towers, antennas, and the like.

In some embodiments, the design data store 164 includes one or more data structures in which design values are stored that characterize the RAN site design for many different RAN sites, including proposed new sites and existing sites. The data structures, for example, can be stored as tables, sheets, a database vectors, mapping data (such as longitude and latitude locations), and various operand values associated with software-driven design of particular RAN sites, as will be described. In some embodiments, the instructions 162 and other data stored in the memory 160 are backed up by a storage 170, where the memory 160 can be viewed as being volatile and the storage 170 being viewed as non-volatile.

In some embodiments, the site design audit system 102 further includes a communication interface 174, input/output (I/O) 176, and optionally also an interface bus 178 over which at least some of the components of the site design audit system 102 communicate. The communication interface 174 can be a network interface and be configured to facilitate communication of a network, the Internet, the cloud, or the like. Other aspects of functionality of the site design audit system 102 are discussed hereinbelow, including with reference to description of the computer system of FIG. 8.

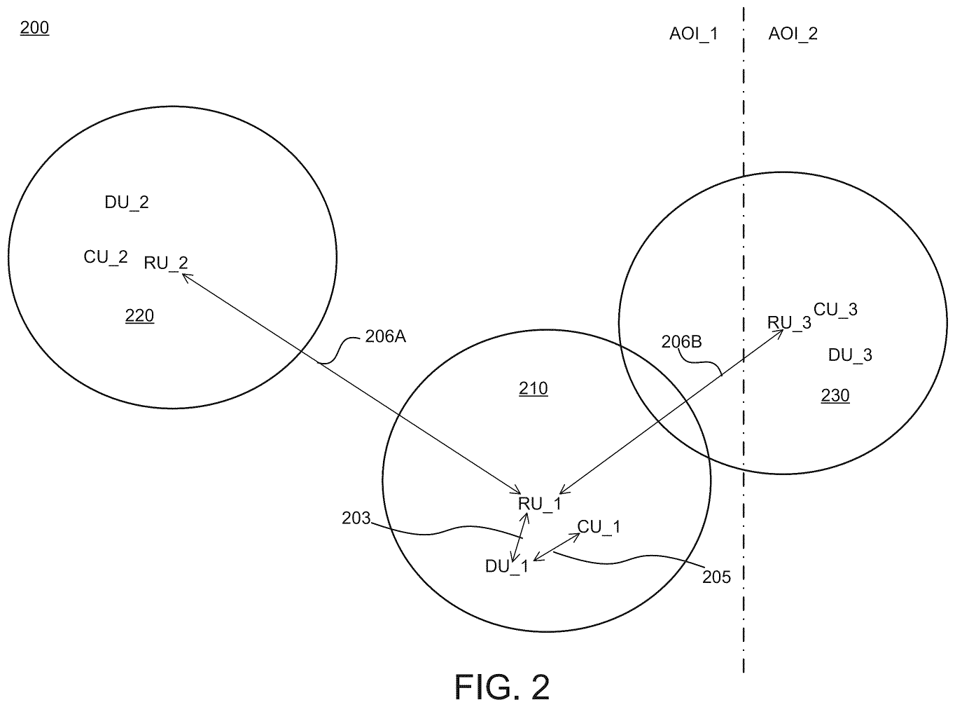

FIG. 2 is a simplified design map 200 of neighboring areas of interest (AOI) that illustrates some of the design parameters for auditing multiple open RAN sites according to various embodiments. For example, the design map 200 can include multiple AOIs and RAN sites, but for simplicity of explanation, the design map 200 includes just a first AOI, labeled AOI_1 and a second AOI, illustrated as AOI_2. Within the first AOI is illustrated a first RAN site 210 and a second RAN site 220 whereas a third RAN site 230 is located within the second AOI illustrates, again for purposes of explanation.

In embodiments, each RAN site includes a radio unit (RU), a distributed unit (DU), and a centralized unit (CU). For example, the first RAN site 210 includes a first RU or RU_1, a first DU or DU_1, and a first CU or CU_1. Further, the second RAN site 220 includes a second RU or RU_2, a second DU or DU_2, and a second CU or CU_2. Finally, the third RAN site 230 (in the second AOI) includes a third RU or RU_3, a third DU or DU_3, and a third CU_3.

For any particular RAN site, multiple antennas are typically connected to each RU, the RU is coupled to a corresponding DU, and the DU is coupled to a corresponding CU. In some embodiments, the RU is located within the RAN tower itself and includes transmitters (e.g., transceivers) in order to be connected to antennas that communicate with UEs in the area. Thus, as will be discussed in more detail, some of the design parameters or operands are driven by distances between each RU and a corresponding DU of each RAN site as well as inter-site distance (ISD) between RAN sites.

For example, the first RU and the first DU may need to be located within a first threshold distance 203 of each other calculated as first logical distance calculation (LDC) value and the first DU and the first CU may need to be located within a second threshold distance 205 of each other calculated as a second LDC value. In embodiments, logical distance calculation (LDC) can be understood as a method used to calculate the effective logical distance between various components in a 5G network, such as between RUs and other network elements like DUs and/or CUs.

For example, in various embodiments, LDC methods help in determining the optimal placement of RUs, DUs, and CUs to ensure efficient network performance and coverage. The LDC-based methods can assist in managing and minimizing latency, which aids 5G applications requiring ultra-reliable low-latency communication (URLLC). The LDC-based methods can facilitate effective network planning and resource allocation by understanding the logical distances in addition to physical distances. By calculating logical distances, network designers can better understand how signals will propagate and where potential issues might arise. The LDC-based methods can help in planning to mitigate interference between adjacent RUs, ensuring better signal quality and network performance. Accurate LDC helps in placing RUs and DUs in a manner that minimizes latency, essential for applications like autonomous vehicles and real-time remote control. The LDC-based methods can ensure that data paths are optimized for maximum throughput, benefiting high-bandwidth applications like video streaming and AR/VR. Logical distance calculations allow for more efficient allocation of network resources, ensuring that bandwidth, power, and processing capabilities are utilized optimally. The LDC-based methods can aid in designing scalable network architectures that can grow with increasing demand without significant performance degradation. The LDC-based methods can help in reducing deployment costs by optimizing the placement of network elements, thus minimizing the need for additional infrastructure. The LDC-based methods can enhance operational efficiency by ensuring that the network is designed to perform well under typical operating conditions, reducing the need for costly adjustments and maintenance.

Further, as mentioned, each RAN site can be designed to be no closer than a threshold ISD depending on factors such as morphology, population size in an AOI, and the like. For example, ISD refers to the distance between two adjacent 5G sites (e.g., base stations that include an RU). By way of example in the design map 200, the first RU is a first ISD 206A from the second RU and the first RU is a second ISD 206B from the third RU. These inter-site distance may be the same in a similar morphology area, but may also be different in mixed morphologies or based on other reasons. Further, as can be seen, there is overlap to cellular coverage between the first RAN site 210 and the third RAN site 230, so these two sites may be unnecessarily close. The disclosed audit may be able to detect and correct for ISD by recommending changing site locations, changing directions of antenna(s), type of antenna(s), height of antenna(s), azimuths of antenna(s), gain of antenna(s), and the like, each of which is a separate design parameter or operand.

In various embodiments, ISD affects the overall coverage area of the network. Shorter ISDs result in more dense site deployments, which can provide better coverage, especially in urban areas. Shorter ISDs can improve network capacity and performance, allowing for higher data rates and lower latency. This is particularly important in high-density areas with many users. Proper ISD planning helps in managing interference between neighboring sites, which can be employed to maintain high-quality service (QoS). The ISD impacts the cost of network deployment. Shorter ISDs mean more sites are needed, increasing both capital and operational expenditures.

In various embodiments, morphology type refers to the physical characteristics and land use of the area where the 5G sites are deployed. Common morphology types include urban, suburban, rural, and specific geographic features like forests, bodies of water, or mountains.

Urban morphology may be characterized by high building density, tall structures, and a large number of users and may requires dense network deployment with shorter ISDs to ensure good coverage and capacity. Building penetration and reflection can affect signal propagation.

Suburban morphology may be characterized by lower building density than urban areas, mix of residential and commercial buildings. Medium ISDs may be used, balancing coverage and capacity needs. The network design should accommodate varied building types and user density.

Rural morphology may be characterized by low building density, wide-open spaces, agricultural or undeveloped land. Longer ISDs are typically used to cover larger areas with fewer users. Network deployment focuses on maximizing coverage rather than capacity.

Special morphologies may be characterized by unique geographic features that can affect signal propagation (e.g., dense foliage, elevation changes). Network planning should account for natural obstacles that can block or reflect signals, possibly requiring specialized equipment or deployment strategies. Both ISD and morphology type are considerations in the effective planning and deployment of 5G networks to ensure optimal performance and coverage tailored to specific environmental and user density conditions.

FIG. 3A is a flow diagram of a method 300A of auditing a new RAN site design according to at least some embodiments. The method 300A may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300A is performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

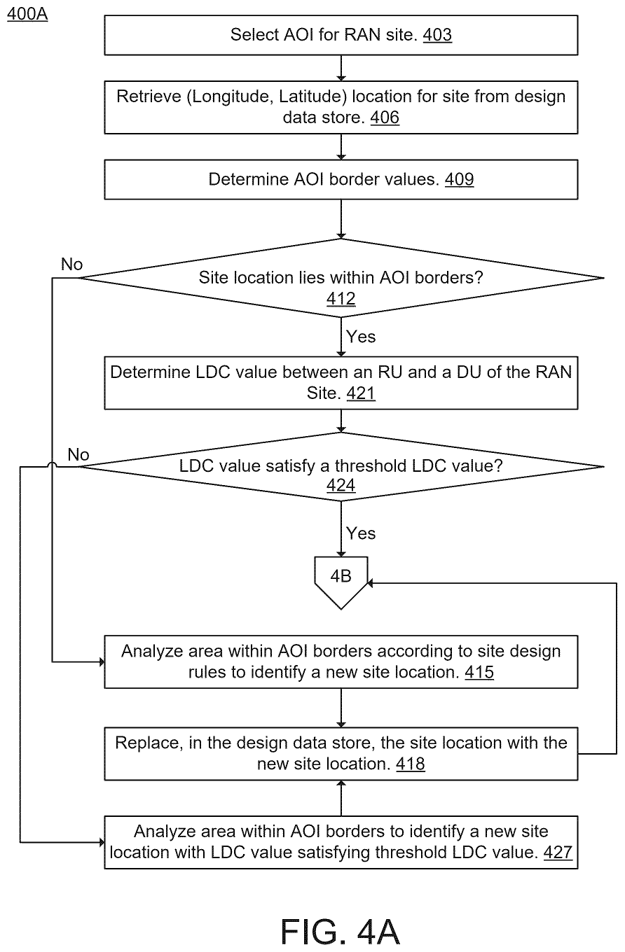

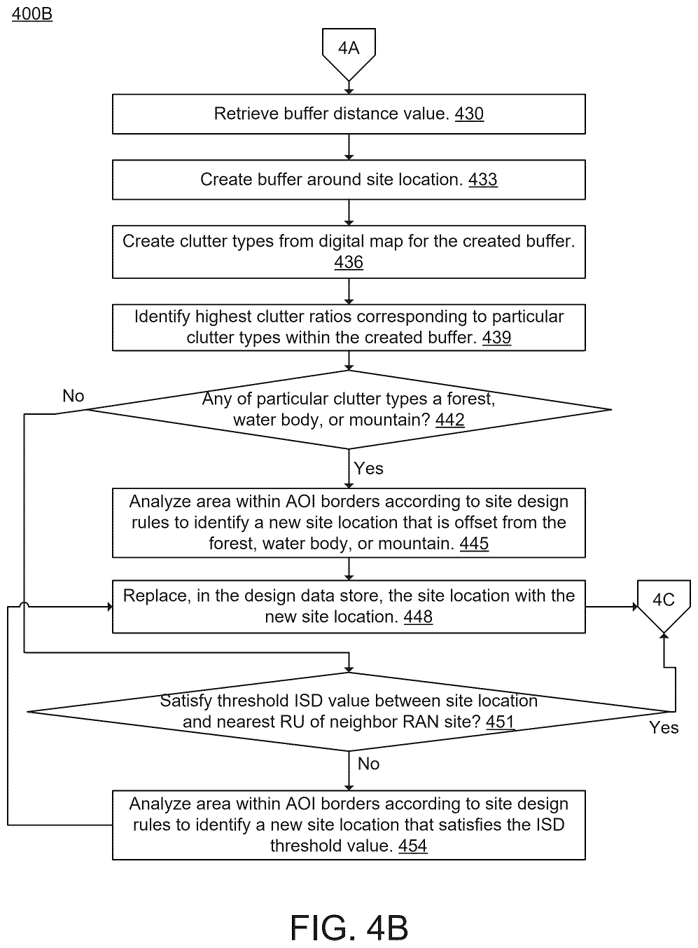

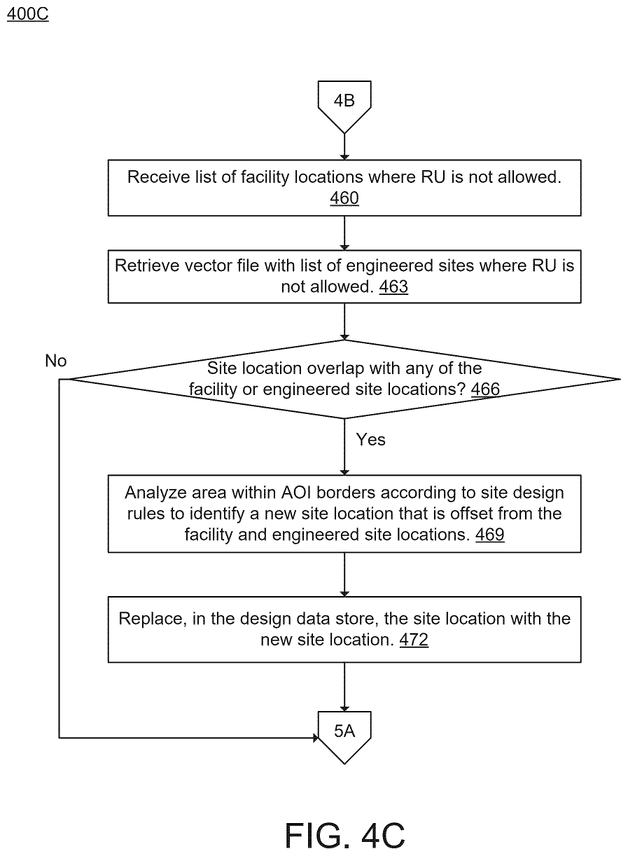

At operation 305, the processing logic receives a selection of a design parameter to be verified that is associated with deployment of a new radio access network (RAN) site. For example, a user can operate a menu in a user interface (UI) to the site design audit system 102 to select a design parameter. In other embodiments, an audit flow automatically selects particular parameters to audit, as will be illustrated in FIG. 4A through FIG. 7B.

At operation 310, the processing logic retrieves a design value of the design parameter from a design data store, e.g., the design data store 164.

At operation 315, the processing logic retrieves one or more threshold values from design guidelines that constrain the design parameter according to site design rules.

At operation 320, the processing logic determines whether the design value satisfies the one or more threshold values. If the design value satisfies the one or more threshold values, the processing logic can loop back to operation 305 to continue to analyze additional design parameters for further auditing purposes. The term “satisfying” or “to satisfy” should generally be understood to mean to comply with threshold values that characterize constraints related to site design guidelines or rules. In some cases, this means at least being equal to the threshold values and in other scenarios it means being less than the threshold values, depending on context of what it means to “comply with” the threshold values, as will be explained in many different contexts hereinafter.

At operation 325, in response to the design value not satisfying the one or more threshold values, the processing logic determines, based on data associated with other RAN site deployments in an area of interest (AOI) that includes a proposed location for the new RAN site, an updated design value that satisfies the one or more threshold values. In this way, the site design audit system 102 can determine a correct value that will resolve a detected error. In at least some embodiments, the data referenced above includes at least one of topographical-related information retrieved from a digital map of a region that includes the AOI, existing RAN site locations, or design values of design parameters associated with the existing RAN site locations.

At operation 330, the processing logic replaces, in the design data store 164, the design value with the updated design value.

At an optional operation 340, the processing logic electronically issues a work order or instructions to a site deployment team that incorporates a plurality of design values, including the updated design value, stored in the design data store 164. Electronically issuing a work order or instructions can, for example, cause the work order or instructions to be sent to a computer terminal or mobile device of the site deployment team, thus automating putting in motion the construction or build of a new RAN site according to a corrected (or finalized) set of design values stored in the design data store 164.

FIG. 3B is a flow diagram of a method of auditing existing RAN site designs according to at least some embodiments. The method 300B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300B is performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 355, the processing logic selects a design parameter to be verified that is associated with existing deployments of a plurality of radio access network (RAN) sites. For example, a user can operate a menu in a user interface (UI) to the site design audit system 102 to select a design parameter. In other embodiments, an audit flow automatically selects particular parameters to audit, as will be illustrated in FIG. 4A through FIG. 7B, in order to perform an on-going audit of existing RAN sites.

At operation 360, the processing logic retrieves design values of the design parameter from a design data store, such as the design data store 164.

At operation 365, the processing logic retrieves one or more threshold values from design guidelines that constrain the design parameter according to site design rules.

At operation 370, the processing logic determines whether the design value satisfies one or more threshold values for a particular RAN site. If the design value satisfies the one or more threshold values, the processing logic can loop back to operation 355 to continue to analyze additional design parameters for further auditing purposes. The term “satisfying” or “to satisfy” should generally be understood to mean to comply with threshold values that characterize constraints related to site design guidelines or rules. In some cases, this means at least being equal to the threshold values and in other scenarios it means being less than the threshold values, depending on context of what it means to “comply with” the threshold values, as will be explained in many different contexts hereinafter.

At operation 375, in response to a design value not satisfying the one or more threshold values for a particular RAN site of the plurality of RAN sites, the processing logic determines an updated design value that satisfies the one or more threshold values based on first data associated with RAN site deployments in an area of interest (AOI) of the plurality of RAN sites. In at least some embodiments, the first data referenced above includes at least one of topographical-related information retrieved from a digital map of a region that includes the AOI, existing RAN site locations, or design values of design parameters associated with the existing RAN site locations.

In some embodiments, determining the updated design value also includes determining the updated design value satisfies one or more additional threshold values based on second data associated with a RAN site located in a neighbor AOI, e.g., the second AOI in FIG. 2. In such embodiments, the first data or the second data includes at least one of topographical-related information retrieved from a digital map of a region that includes the AOI and the neighbor AOI, locations of the plurality of RAN sites, or design values of design parameters associated with the locations.

At operation 380, the processing logic replaces the design value in the design data store 164 with the updated design value.

At optional operation 385, in response to a design value not satisfying the one or more threshold values for a particular RAN site of the plurality of RAN sites, the processing logic electronically issues a work order or instructions to a maintenance team to update a configuration of the particular RAN site based on the updated design value. Electronically issuing a work order or instructions can, for example, cause the work order or instructions to be sent to a computer terminal or mobile device of the maintenance team, thus automating putting in motion the alteration (or at least reconfiguration) of an existing RAN site according to a corrected (or finalized) set of design values stored in the design data store 164.

In various embodiments, the methods disclosed with reference to FIG. 4A through FIG. 7B can be understood as extensions to or more-detailed descriptions of the methods 300A and 300B that have just been described. Further, each method described in FIG. 4A through FIG. 7B can be performed alone or in conjunction with another of the described methods. Thus, although each Figure transitions to a next Figure, may give a sense of needing to perform all of the methods in any given audit, each method need not all be performed to perform a complete audit. For example, a partial audit is possible in which one or more of the audit checks can be performed where some of the methods describe more than one audit check. A partial audit can be triggered by user queries or automatically based on some criteria such as time between auditing certain aspects of the RAN site designs.

FIG. 4A, FIG. 4B, and FIG. 4C are flow diagrams of methods 400A, 400B, 400C for verifying a location for an open RAN site based on design rules associated with AOI, RAN component distances, and cluttery types according to various embodiments. The methods 400A, 400B, 400C may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 400A, 400B, 400C are performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

With reference to the method 400A of FIG. 4A, in some embodiments, the design parameter is the proposed location, the design value is a longitude and latitude point, and the one or more threshold values include at least one of AOI border values or a LDC value between a radio unit (RU) and a distribution unit (DU) of the RAN site.

At operation 403, the processing logic selects an AOI for a RAN site audit.

At operation 406, the processing logic retrieves a location (e.g., a longitude, latitude point) for the site from the design data store 164.

At operation 409, the processing logic determines AOI border values associated with the AOI, e.g., which may be obtained from the site deployment data 166 in optional combination with the digital maps 168.

At operation 412, the processing logic determines whether the site location lies within the AOI borders. If not, the processing logic, at operation 415, analyzes the area within the AOI borders according to site design rules to identify a new site location. At operation 418, the processing logic replaces, in the design data store 164, the site location with the new site location.

If, at operation 412, the site location was within (e.g., satisfied) the AOI borders, the processing logic, at operation 421, determines an LDC value between an RU and a DU of the RAN site. At operation 424, the processing logic determines whether the LDC value satisfies a threshold LDC value (e.g., is less than a maximum distance the DU can be located from the RU). If the LDC value is within this threshold LDC value, the processing logic proceeds to FIG. 4B.

If, at operation 424, the LDC value does not satisfy the threshold LDC value, the processing logic, at operation 427, analyzes the area within the AOI border to identify a new site location in which the LDC value satisfies the threshold LDC value and otherwise complies with other site design guidelines and rules. At operation 418, the processing logic replaces, in the design data store 164, the site location with the new site location.

With additional reference to the method 400B of FIG. 4B, in some embodiments, the design parameter is the proposed location, the design value is a longitude and latitude point, and the one or more threshold values comprise at least one of a set of highest clutter ratios corresponding to clutter types in which the RU is not allowed an inter-site distance (ISD) value between the proposed location and a nearest radio unit (RU) of a neighbor RAN site.

At operation 430, the processing logic retrieves a buffer distance value.

At operation 433, the processing logic creates a buffer around the site location using the buffer distance value.

At operation 436, the processing logic creates clutter types from the digital maps 168 for the created buffer.

At operation 439, the processing logic identifies highest clutter ratios corresponding to particular clutter types within the created buffer. For example, the three clutter types having the highest clutter ratios compared to all clutter types determined in operation 436 would be output by the processing logic as the particular clutter types.

At operation 442, the processing logic determines whether any of the particular clutter types are a forest, water body, or mountain. If not, the processing logic flows to operation 451. Otherwise, in response to the particular clutter types being a forest, water body, or mountain, the processing logic, at operation 445, analyzes the area within the AOI borders according to site design rules to identify a new site location that is offset from (e.g., not within) the forest, water body, or mountain.

At operation 448, the processing logic replaces, in the design store 164, the site location with the new site location.

At operation 451, the processing logic determines whether the ISD value satisfies the threshold ISD value as between the site location and the nearest RU of a neighbor RAN site. Is some embodiments, such as illustrated in FIG. 2, this determination is made with reference to a RAN site in a neighbor AOI. If the threshold ISD value is satisfied, the method 400B can flow on to the method 400C of FIG. 4C.

At operation 454, the processing logic, in response to not satisfying the threshold ISD value, analyzes the area within the AOI borders according to the site design guidelines or rules to identify a new site location that satisfies the ISD threshold value.

At operation 448, the processing logic replaces, in the design store 164, the site location with the new site location.

With further reference to FIG. 4C, in some embodiments, the design parameter is the proposed location, the design value is a longitude and latitude point, and the one or more threshold values include a list of facility locations where the RU is not allowed or a vector file containing engineered sites where the RU is not allowed, wherein not satisfying the one or more threshold values means the design value overlaps with the one or more threshold values.

At operation 460, the processing logic receives a list of facility locations where the RU of the audited site is not allowed. These facility locations can be, for example, a hospital, school, airport, military base, the like. Some airports do not want mm-wave towers near the airport that might interfere with control tower communications, for example.

At operation 463, the processing logic retrieves a vector file with a list of engineered sites where the RU is not allowed. Engineered sites might include, for example, streets, highways, bridges, railways, and the like sites that have been engineered.

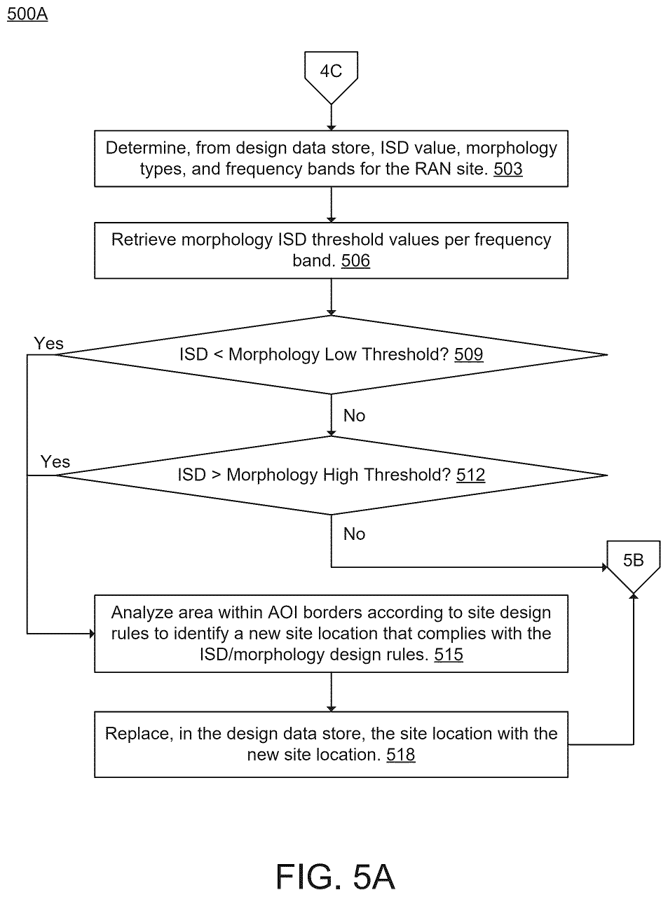

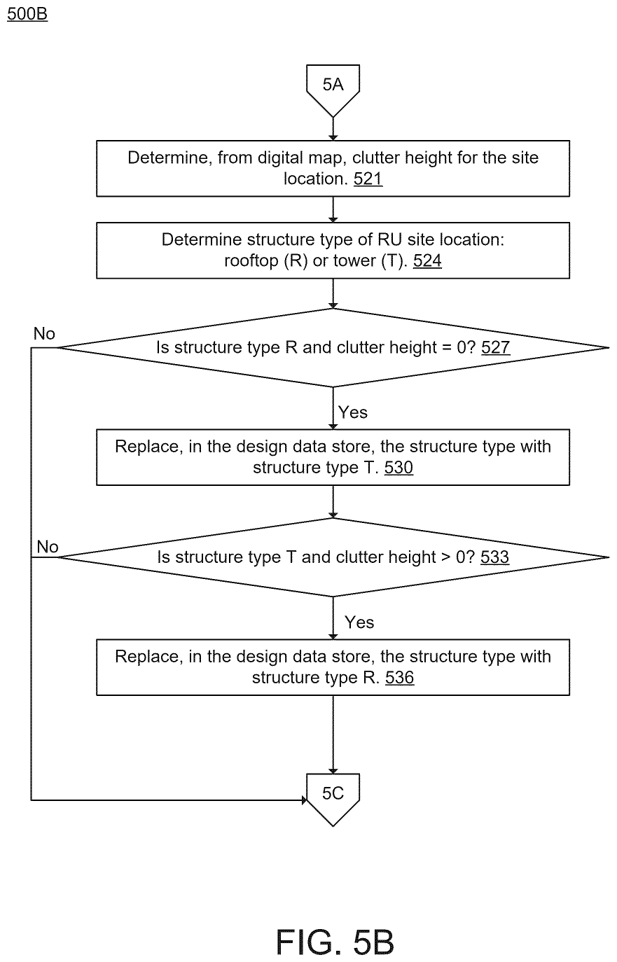

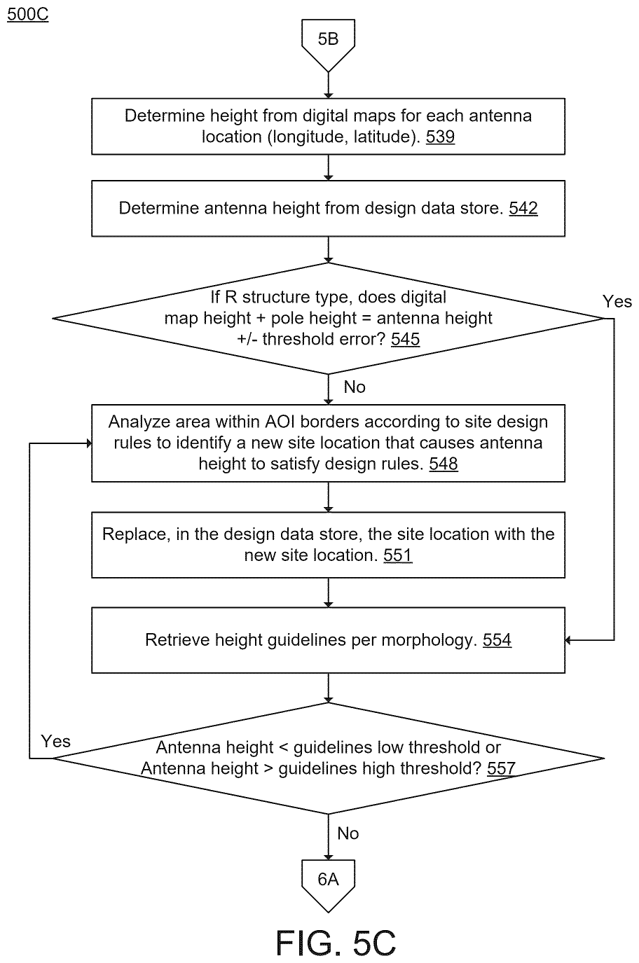

At operation 466, the processing logic determines whether the site locations overlaps with any of the facility or engineered site locations. Thus, in this example, “satisfying” the one or more threshold values is overlapping or matching with one of these facility or engineered site locations. If no, then the method flow may continue to FIG. 5A.

At operation 469, in response to site location overlapping, at operation 466, with a facility or engineered site, the processing logic analyzes the area within the AOI borders according to site design rules to identity a new site location that is offset from the facility and engineered site locations. For example, the processing logic can determine a length, width, or other dimension of the facility or engineered site and find an approved site adjacent to (but that does not intersect with) the facility or engineered site. In some situations, such as next to a highway or street, the new location can be co-located with a RAN site of another telecommunications operator.

At operation 472, the processing logic replaces, in the design data store 164, the site location with the new site location.

FIG. 5A, FIG. 5B, FIG. 5C are flow diagrams of methods 500A, 500B, 500C for verifying a location for an open RAN site based on design rules associated with inter-site distance (ISD), morphology, clutter height compared to structure type, and antenna height compared to structure type according to various embodiments. The methods 500A, 500B, 500C may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 500A, 500B, 500C are performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

With reference to FIG. 5A, in some embodiments, the design parameter is the proposed location, the design value is a longitude and latitude point, and the one or more threshold values include an inter-site distance (ISD) value between the proposed location and a nearest radio unit (RU) of a neighbor RAN site. In some embodiments, determining the updated design value includes determining a new proposed location that spreads out RUs of RAN sites within the AOI according to the ISD value that depends on morphology of the new proposed location At operation 503, the processing logic determines, the design data store 164, an ISD value to a nearest neighbor site, morphology types within a buffer area of the RAN site, and frequency bands for the RAN site.

At operation 506, the processing logic retrieves morphology ISD threshold values per frequency band. For example, for a dense urban morphology, the ISD threshold values could be 100-200 m, for an urban morphology the ISD threshold values could be 200-300 m, for a suburban morphology the ISD threshold values could be 300-600 m, and for a rural morphology, the ISD threshold values could be 600-300 m.

At operation 509, the processing logic determines whether the ISD value is less than the low threshold value for the morphology. If not, the method 500A can flow on to FIG. 5B.

At operation 512, the processing logic determines whether the ISD value is greater than the high threshold value for the morphology. If not, the method 500A can flow on to FIG. 5B.

At operation 515, in response to the ISD value either being less than the low threshold value (at operation 509) or greater than the high threshold value (at operation 512), the processing logic analyzes the area within the APOI borders according to the site design guidelines or rules to identify a new site location that complies with the ISD/morphology design rules along with other design rules.

At operation 518, the processing logic replaces, in the design data store 164, the site location with the new site location.

With additional reference to FIG. 5B, in some embodiments, the design parameter is a structure type, the design value is a clutter height value, and the one or more threshold values is a rooftop value or a tower value.

At operation 521, the processing logic determines, from the digital map, a clutter height for the site location. The clutter height can make reference here to the geography where a site tower is to be located (or is located) such as on the ground (e.g., clutter height equal to “0”) or on a building (e.g., clutter height is greater than zero).

At operation 524, the processing logic determines a structure type on which the RU is placed at the RAN site, whether a rooftop (R) or tower (T).

At operation 527, the processing logic determines whether the structure type is rooftop and clutter height equal to zero, indicating a mismatch in structure type and clutter height. If no, the method 500B can flow on to FIG. 5C. If yes, at operation 530, the processing logic replaces, in the design data store 164, the structure type with structure type tower (T).

At operation 533, the processing logic determines whether the structure type is tower and the clutter height is greater than zero, which again is a structure type and clutter height mismatch. If no, the method 500B can flow on to FIG. 5C. If yes, at operation 546, the processing logic replaces, in the design data store, the structure type with structure type rooftop (R).

With additional reference to FIG. 5C, in some embodiments, the design parameter is an antenna height, the design value is an antenna height value that accounts for an antenna pole height in response to the antenna being on a rooftop, and the one or more threshold values comprises a set of allowed antenna heights depending on morphology.

At operation 539, the processing logic determines a height from digital maps for each antenna location (longitude, latitude). At operation 542, the processing logic determines antenna height from the design data store 164.

At operation 545, the processing logic determines, for a rooftop structure type, whether a digital map height and pole height (of a tower) is equal to the antenna height plus or minus a threshold error. If yes, the method 500C may loop forward to operation 554. If no, at operation 548, the processing logic analyzes the area within the AOI borders according to site design rules to identify a new site location that causes antenna height to satisfy design rules.

At operation 551, the processing logic replaces, int eh design data store 164, the site location with the new site location.

At operation 554, the processing logic retrieves height guidelines per morphology. For example, a dense urban morphography might correspond to antenna height of 30-50 m, an urban morphology might correspond to antenna height of 20-30 m, a suburban morphology might correspond to antenna height of 15-25 m, and a rural morphology might correspond to antenna height of 25-45 m, although these are merely examples.

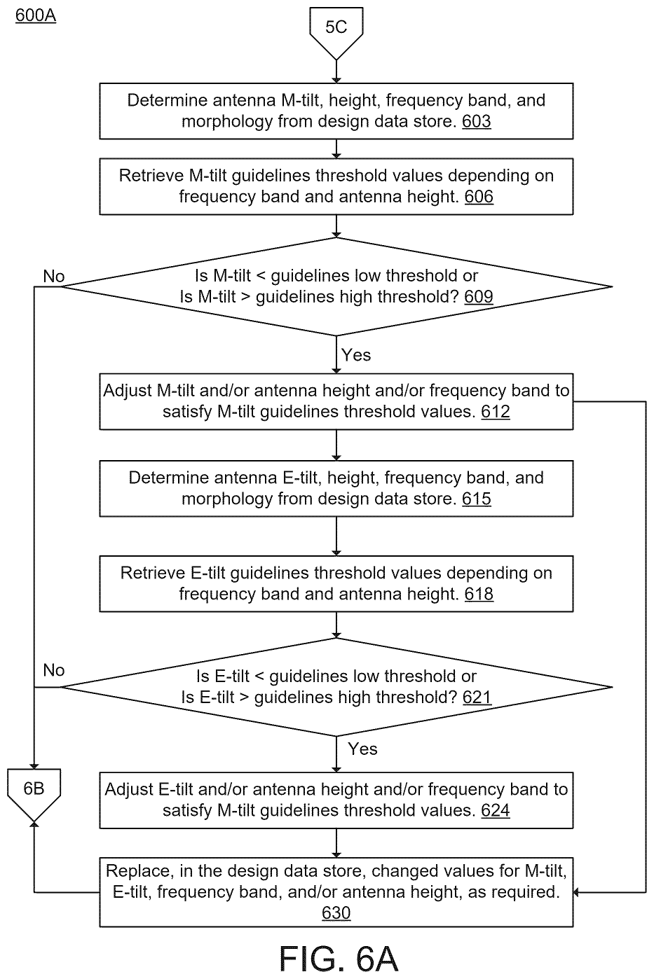

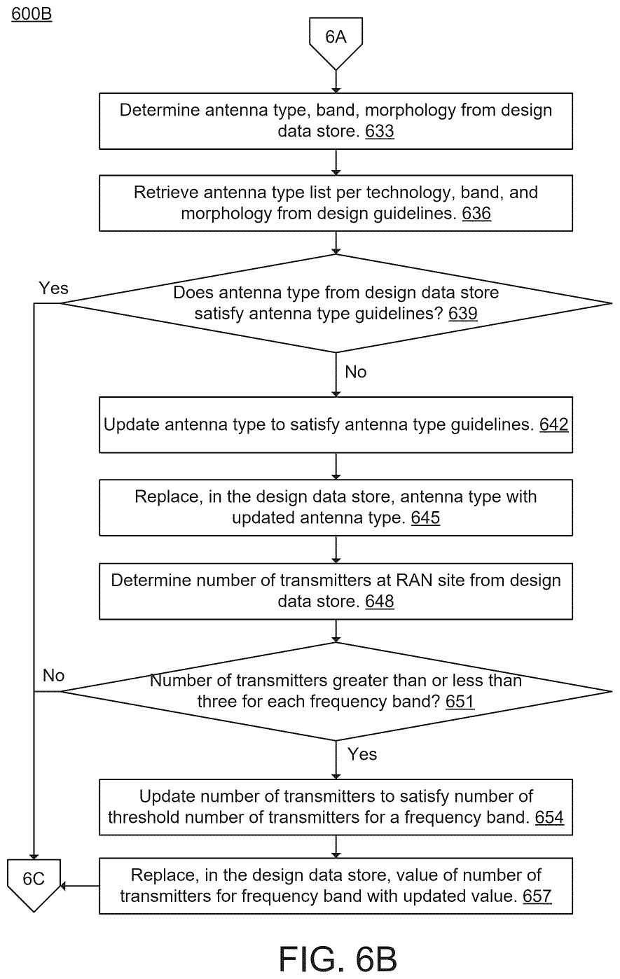

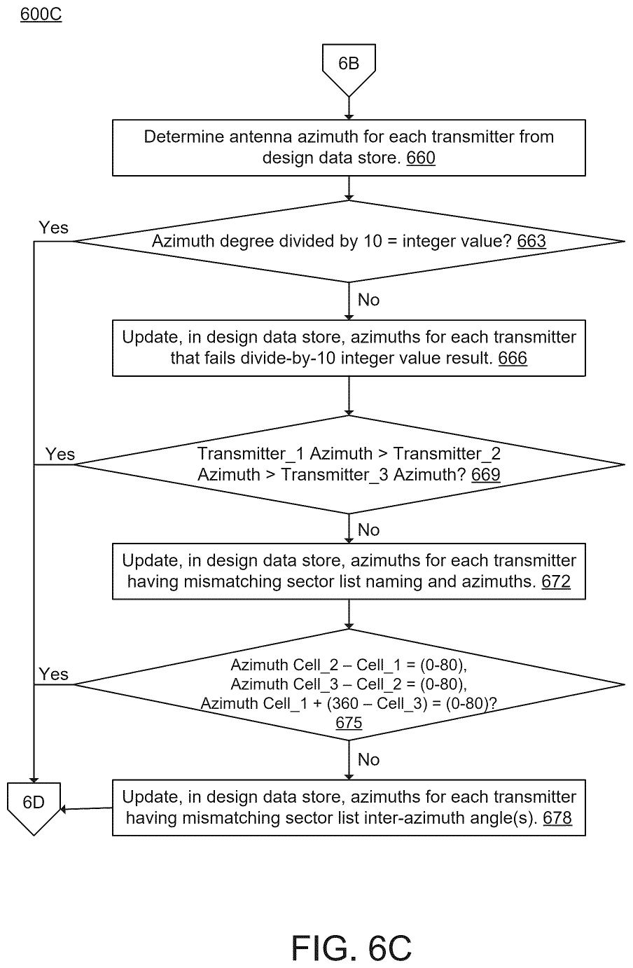

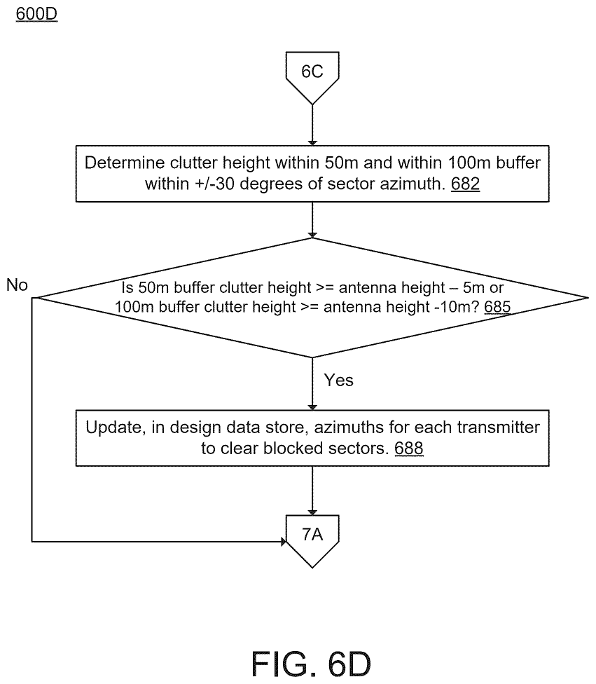

At operation 557, the processing logic determines whether the antenna height is less than a low threshold value or greater than a high threshold value from the site design guidelines. If no, the processing logic may continue on to FIG. 6A. Otherwise, the method 500C can loop back to operations 548 and 551 to adjust the site location so that the antenna height satisfies the antenna height guidelines.

FIG. 6A, FIG. 6B, FIG. 6C, FIG. 6D are flow diagrams of methods 600A, 600B, 600C, 600D for verifying M-tilt and E-tilt of antennas, antenna type, frequency band, number of transmitters, and azimuths of antennas for each transmitter according to some embodiments. The methods 600A, 600B, 600C, 600D may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 600A, 600B, 600C, 600D are performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

With reference to FIG. 6A, in some embodiments, the design parameter is an antenna tilt, the design value is at least one of a mechanical antenna tilt value or an electrical antenna tilt value, and the one or more threshold values include a set of allowed tilt ranges that depend on a combination of frequency band and the antenna height value.

At operation 603, the processing logic determines antenna mechanical tilt (M-tilt), frequency band, and morphology from the design data store 164 for the RAN site.

At operation 606, the processing logic retrieves M-tilt threshold values according to site design guidelines or rules that depend on frequency band and antenna height. For example, for an Amazon Services (AWS) band, and urban morphology, an M-tilt of 0 degrees may correspond to less than 20 m height, an M-tilt of 2 degrees may correspond to a height of between 20-30 m, an M-tilt of 4 degrees may correspond to a height of between 30-60 m, and an M-tilt of 6 degrees may correspond to a height that is greater than 60 m.

At operation 609, the processing logic determines whether the M-tilt value is less than the low threshold or greater than the high threshold for the site design guidelines. If no, the method 600A may proceed to FIG. 6B.

At operation 612, in response to not satisfying, at operation 609, the M-tilt threshold value, the processing logic adjusts the M-tilt and/or antenna height and/or frequency band to satisfy M-tilt guidelines threshold values. The method 600A can then flow to operation 630.

At operation 615, the processing logic determines an antenna electrical tilt (E-tilt, height, frequency band, and morphology from the design data store 164 for the RAN site.

At operation 618, the processing logic retrieves E-tilt threshold values depending on frequency band and antenna height. For example, for an AWS band, and urban morphology, an E-tilt of 2-4 degrees may correspond to less than 20 m height, an E-tilt of 3-6 degrees may correspond to a height of between 20-40 m, an E-tilt of 4-8 degrees may correspond to a height of between 40-50 m, and an E-tilt of 6-10 degrees may correspond to a height that is greater than 50 m.

At operation 621, the processing logic determines whether the E-tilt value is less than the low threshold or greater than the high threshold for the site design guidelines. If no, the method 600A may proceed to FIG. 6B.

At operation 624, in response to not satisfying, at operation 609, the E-tilt threshold value, the processing logic adjusts the E-tilt and/or antenna height and/or frequency band to satisfy E-tilt guidelines threshold values.

At operation 630, the processing logic replaces, in the design data store 164, changed values for M-tilt, E-tilt, frequency band, and/or antenna height, as has been updated by the processing logic at operation 612 and/or operation 624.

With additional reference to FIG. 6B, in some embodiments, the design parameter is antenna type, the design value corresponds to the antenna type, and the one or more threshold values comprise at least one of directional type of antenna (e.g., omni-directional, directional), gain level (e.g., power level), number of antenna elements, and antenna weight. The directional type of antenna can depend on number of antennas on the same pole, morphology, and/or obstacles identified in a buffer area outside the antenna. Some antennas are oriented with a vertical beamwidth or horizontal beamwidth. For example, a pole can include, on one side, three antennas pointed to three different sectors. One could add a fourth antenna, but now the antennas are closer to each other, so would want to minimize horizontal beam width to minimize interference from antennas overlapping. The gain level can depend on available power, morphology, and distance that needs to be covered by a given antenna. For example, in dense urban environments, design could be directed at using lower-gain antennas while in rural environment, the design could be directed at using higher-gain antennas. The number of antenna elements can depend on the level of MIMO communication (e.g., 4×4, 16×16, 64×64, or the like). The antenna weight may have to vary depending on whether the RAN site is within an earthquake zone.

At operation 633, the processing logic determines antenna type, frequency band, and morphology from the design data store 164.

At operation 636, the processing logic retrieves antenna type per technology, frequency band, and morphology from the design guidelines or rules.

At operation 639, the processing logic determines whether the antenna type from the design data store 164 satisfies the antenna type guidelines or rules. If yes, the method 600B can flow on to FIG. 6C.

At operation 642, in response to detecting, at operation 639, the wrong antenna type the processing logic updates the antenna type to satisfy the antenna type guidelines.

At operation 645, the processing logic replaces, in the design data store 164, the antenna type with the updated antenna type.

At operation 648, the processing logic determines the number of transmitters at the RAN site from the design data store 164.

At operation 651, the processing logic determines whether the number of transmitters is greater than or less than three for the RAN site. If no, the method 600B can flow on to FIG. 6C.

At operation 654, in response to the number of transmitters at the RAN site, according to operation 651, indicating a single sector, two or four sectors, the processing logic updates the number of transmitters to satisfy a number of threshold number of transmitters for a frequency band.

At operation 657, the processing logic replaces, in the design data store, the value of the number of transmitters for the frequency band with an updated value.

With additional reference to FIG. 6C and FIG. 6D, in some embodiments, the design parameter is antenna azimuths and the design value corresponds to azimuths of each antenna. In such embodiments, the one or more threshold values can include a number of transmitters per site allowed per frequency band. The one or more threshold values can further, for antennas coupled to each transmitter, include: that each azimuth divided by ten is an integer value; that the azimuths correspond to a plurality of non-overlapping sectors of coverage; one or more allowed inter-azimuth angles associated with the azimuths; or buffer clutter height values allowed within an angle range of each of the plurality of non-overlapping sectors.

At operation 660, the processing logic determines an antenna azimuth for each transmitter from the design data store 164. An azimuth, for example, can be associate with direction the antennas coupled to the transmitter. Azimuths can depend on morphology, obstacles, and neighbor RAN sites and/or neighbor AOI. For example, in an urban environment, antennas can be directed to streets and open areas and away from obstacles. Antennas directed at a building, which would block the electromagnetic waves would not be useful. Directionality from azimuths can also be used to better cover each AOI and avoid large overlaps from different sites.

At operation 663, the processing logic determines whether, when the azimuth degree is divided by 10, the result is an integer value. If yes, the method 600C can flow on to FIG. 6D.

At operation 666, in response to resulting in a non-integer value, at operation 663, the processing logic updates, in the design data store, the azimuth for each transmitter that fails to generate a divide-by-10 integer value result.

At operation 669, the processing logic determines whether a first azimuth of a first transmitter is greater than a second azimuth of a second transmitter and whether the second azimuth of the second transmitter is greater than a third azimuth of a third transmitter, which tests for whether the transmitter azimuths create overlapping sectors. If yes, they are non-overlapping, the method 600C can flow on to FIG. 6D.

At operation 672, in response to the transmitter azimuths generating, at operation 669, overlapping sectors, the processing logic updates, in the design data store 164, azimuths for each transmitters having mismatching sectors list naming and azimuths.

At operation 675, the processing logic determines whether any inter-azimuth cell is greater than 80 degrees. For example, the azimuth between Cell_2 and Cell_1 should no greater than 80 degrees, the azimuth between Cell_2 and Cell_3 should be no greater than 80 degrees, and the azimuth between Cell_1 and Cell_3 is no greater than 80 degrees. If yes, the method 600C can flow on to FIG. 6D.

At operation 678, in response to determining (or detecting), at operation 675, mismatching inter-azimuths angles, the processing logic updates, in the design data store 164, one or more azimuths for each transmitter having a mismatching sector list of one or more inter-azimuth angles.

With additional reference to FIG. 6D, at operation 682, the processing logic determines a clutter height within a 50 m buffer and within a 100 m buffer, within +/−30 degrees of a sector azimuth.

At operation 685, the processing logic determines whether the 50 m buffer clutter height is greater than or equal to the antenna height minus 5 m and whether the 100 m buffer clutter height is greater than or equal to the antenna height minus 10 m, e.g., to test buffer clutter height values allowed within an angle range of each of the plurality of non-overlapping sectors. If no, the method 600D can flow on to FIG. 6D.

At operation 688, in response to a buffer clutter height mismatch, the processing logic updates, in the design data store 164, azimuths for each transmitter to clear blocked sectors.

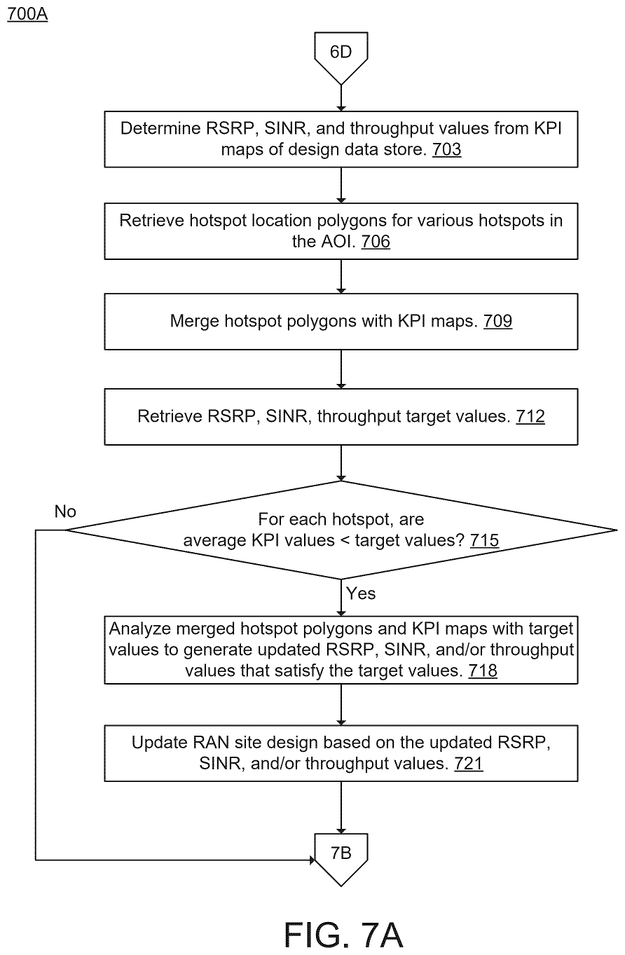

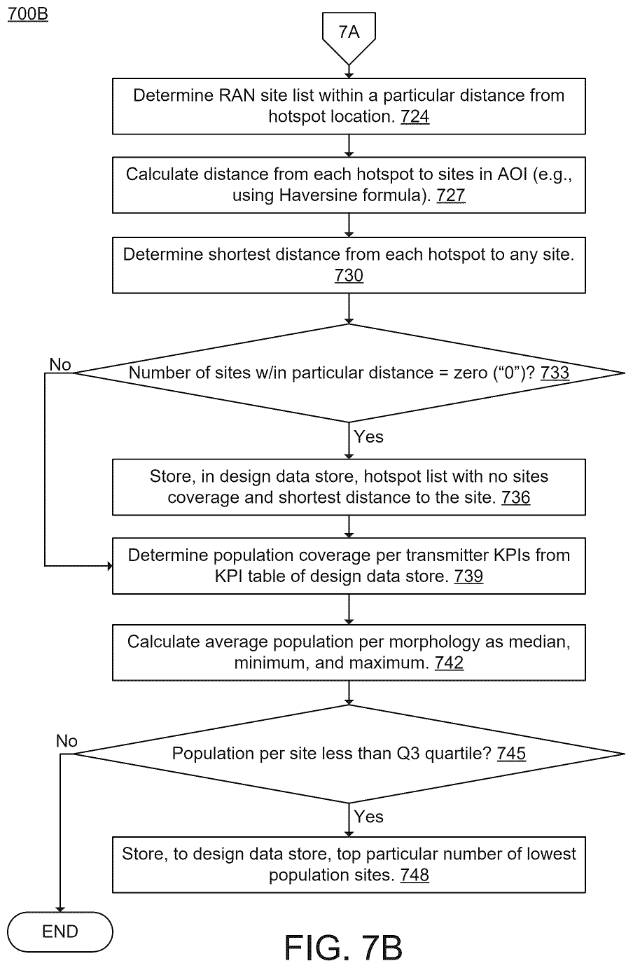

FIG. 7A is a flow diagram of a method 700A for verifying reserve signal receive power (RSRP), signal-to-interference noise ratio (SINR), and throughput target values associated with key performance indicators for particular hotspots according to some embodiments. The method 700A may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 700A is performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

In some embodiments, the design parameter is hotspot coverage and the design value includes locations of hotspot polygons. In such embodiments, the one or more threshold values can include reserve signal receive power (RSRP) target values for RAN site locations, signal-to-interference noise ratio (SINR) target values for RAN site locations, and/or throughput target values for RAN site locations in the AOI.

At operation 703, the processing logic determines the RSRP, SINR, and throughput values from KPI maps in the design data store 164.

At operation 706, the processing logic retrieves hotspot location polygons for various hotspots in the AOI. For example, a coverage hotspot map can indicate some areas that still need coverage while other areas are well covered, e.g., in endeavoring to obtain sufficient cellular coverage within each AOI. Engineers can use a coverage tool simulation to see get a coverage layer or coverage map. From the existing network, can use a network companion application (NCE) that measures signal level and quality from subscribers that is pushed back to a database (e.g., stored within the site deployment data) and made available to query GEO-located data that goes into coverage maps and the database.

At operation 709, the processing logic merges the hotspot polygons with the KPI maps.

At operation 712, the processing logic retrieves RSRP, SINR, and throughput target values, e.g., from site design guidelines or rules.

At operation 715, the processing logic determines, for each hotspot, whether average KPI values are less than target values for RSRP, SINR, and throughput. In no, the method 700A can flow on to FIG. 7B.

At operation 718, in response to determining, at operation 715, that any of the RSRP, SINR, or throughput average KPI values are less than the target values, the processing logic analyzes the merged hotspot polygons and KPI maps with target values to generate updated RSRP, SINR, and/or throughput values that satisfy the target values.

At operation 721, the processing logic updates the RAN site design with the design data store 164 with the updated RSRP, SINR, and throughput values. In some embodiments, this update in one or more design values will cause changes in the KPI maps as well.

In some embodiments of FIG. 3B in conducting on-going audits of existing sites, the operations of method 700A can further include, receiving, based on a first azimuth, a distance target value for a distance between a radio unit (RU) of the particular RAN site and a hotspot polygon of the hotspot polygons. The operations can further include, in response to the distance between the RU and the hotspot polygon not satisfying the distance target value, determining a second azimuth that causes the distance to satisfy the distance target value to at least one of the hotspot polygons. The processing logic can then update, in the design data store 164, the site design values for azimuths for a given transmitter.

FIG. 7B is a flow diagram of a method 700B for verifying site location relative to hotspot(s) and population coverage based on KPIs and morphology according to some embodiments. The method 700B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 700B is performed by the site design audit system 102 of FIGS. 1A-1C. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

In some embodiments, the design parameter is a population size and the design value is a population size value within a predetermined distance of the proposed location. In such embodiments, the one or more threshold values include average population coverage per transmitter and average population coverage based on morphology and including median, minimum, and maximum population target values.

At operation 724, the processing logic determines a RAN site list within a particular distance from a hotspot location.

At operation 727, the processing logic calculates the distance from each hotspot to sites in the AOI, e.g., using the Haversine formula.

At operation 730, the processing logic determines a shortest distance from each hotspot to any RAN site.

At operation 733, the processing logic determines whether the number of sites within a particular distance is equal to zero. If no, the method 700B can skip to operation 739.

At operation 736, in response to determining, at operation 733, the number of sites are within the particular distance being equal to zero, the processing logic stores, in the design data store 164, a hotspot list with no sites coverage and a shortest distance to the RAN site.

At operation 739, the processing logic determines a population coverage per transmitter KPIs from the KPI table of the design data store 164.

At operation 742, the processing logic calculates the average population per morphology as median, minimum, and maximum.

At operation 745, the processing logic determines whether the population values per site is less than the Q3 quartile. For example, population size can be characterized within quartiles, where Q3 and Q4 are the largest population sizes and Q1 and Q2 are the smallest population sizes. If there are none, the method 700B can end.

At operation 748, in response determining, at operation 745, to the population size being a Q1 or Q2 quartile population size, the processing logic stores, to the design store, the top particular number of lowest population sites. In this way, the site design audit system 102 determines which areas have the lowest population and provide lowest priority for these low-population areas.

FIG. 8 illustrates a block diagram illustrating an exemplary computer device 800 (or computing device), in accordance with implementations of the present disclosure. Computer device 800 can correspond to the site design audit system 102 (or device), as described above. Example computer device 800 can be connected to other computer devices in a LAN, an intranet, an extranet, and/or the Internet. Computer device 800 can operate in the capacity of a server in a client-server network environment. Computer device 800 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 800 can include a processing device 802 (also referred to as a processor, CPU, or GPU), a volatile memory 804 (or main memory, e.g., read-only memory (ROM), flash memory, dynamic random access memory (DRAM) such as synchronous DRAM (SDRAM), etc.), a non-volatile memory 806 (e.g., flash memory, static random access memory (SRAM), etc.), and a secondary memory (e.g., a data storage device 816), which can communicate with each other via a bus 830.

Processing device 802 (which can include processing logic 822) represents one or more general-purpose processing devices such as a microprocessor, central processing unit, or the like. More particularly, processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 can also be one or more special-purpose processing devices such as an ASIC, a FPGA, a digital signal processor (DSP), network processor, or the like. In accordance with one or more aspects of the present disclosure, processing device 802 can be configured to execute instructions performing the method disclosed herein.

Example computer device 800 can further comprise a network interface device 808, which can be communicatively coupled to a network 820. Example computer device 800 can further comprise a video display 810 (e.g., a liquid crystal display (LCD), a touch screen, or a cathode ray tube (CRT)), an alphanumeric input device 812 (e.g., a keyboard), a cursor control device 814 (e.g., a mouse), and an acoustic signal generation device 818 (e.g., a speaker).

Data storage device 816 can include a computer-readable storage medium (or, more specifically, a non-transitory computer-readable storage medium) 824 on which is stored one or more sets of executable instructions 826. In accordance with one or more aspects of the present disclosure, executable instructions 826 can comprise executable instructions performing the method disclosed herein.

Executable instructions 826 can also reside, completely or at least partially, within volatile memory 804 and/or within processing device 802 during execution thereof by example computer device 800, volatile memory 804 and processing device 802 also constituting computer-readable storage media. Executable instructions 826 can further be transmitted or received over a network via network interface device 808.

While the computer-readable storage medium 824 is shown in FIG. 8 as a single medium, the term “computer-readable storage medium” or “non-transitory computer-readable storage medium storing instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving a selection of a design parameter to be verified that is associated with deployment of a new radio access network (RAN) site;
retrieving a design value of the design parameter from a design data store;
retrieving one or more threshold values from design guidelines that constrain the design parameter according to site design rules; and
in response to the design value not satisfying the one or more threshold values:
determining, based on data associated with other RAN site deployments in an area of interest (AOI) that includes a proposed location for the new RAN site, an updated design value that satisfies the one or more threshold values; and
replacing, in the design data store, the design value with the updated design value.

2. The computing system of claim 1, wherein the operations further comprise electronically issuing a work order or instructions to a site deployment team that incorporates a plurality of design values, including the updated design value, stored in the design data store.

3. The computing system of claim 1, wherein the data comprises at least one of topographical-related information retrieved from a digital map of a region that includes the AOI, existing RAN site locations, or design values of design parameters associated with the existing RAN site locations.

4. The computing system of claim 1, wherein the design parameter is the proposed location, the design value is a longitude and latitude point, and the one or more threshold values comprise at least one of AOI border values or a logical distance calculation (LDC) value between a radio unit (RU) and a distribution unit (DU) of the RAN site.

5. The computing system of claim 1, wherein the design parameter is the proposed location, the design value is a longitude and latitude point, and the one or more threshold values comprise at least one of a set of highest clutter ratios corresponding to clutter types in which the RU is not allowed, a list of facility locations where the RU is not allowed, or a vector file containing engineered sites where the RU is not allowed, wherein not satisfying the one or more threshold values means the design value overlaps with the one or more threshold values.

6. The computing system of claim 1, wherein the design parameter is the proposed location, the design value is a longitude and latitude point, and the one or more threshold values comprise an inter-site distance (ISD) value between the proposed location and a nearest radio unit (RU) of a neighbor RAN site, and wherein determining the updated design value comprises determining a new proposed location that spreads out RUs of RAN sites within the AOI according to the ISD value that depends on morphology of the new proposed location.

7. The computing system of claim 1, wherein the design parameter is a structure type, the design value is a clutter height value, and the one or more threshold values comprise a rooftop value or a tower value.

8. The computing system of claim 1, wherein the design parameter is an antenna height, the design value is an antenna height value that accounts for an antenna pole height in response to the antenna being on a rooftop, and the one or more threshold values comprises a set of allowed antenna heights depending on morphology.

9. The computing system of claim 8, wherein the design parameter is an antenna tilt, the design value is at least one of a mechanical antenna tilt value or an electrical antenna tilt value, and the one or more threshold values comprise a set of allowed tilt ranges that depend on a combination of frequency band and the antenna height value.

10. The computing system of claim 1, wherein the design parameter is antenna type, the design value corresponds to the antenna type, and the one or more threshold values comprise at least one of directional type of antenna, gain level, number of antenna elements, and antenna weight.

11. The computing system of claim 1, wherein the design parameter is antenna azimuths, the design value corresponds to azimuths of each antenna, and the one or more threshold values comprise:
a number of transmitters per site allowed per frequency band; and
for antennas coupled to each transmitter at least one of:
that each azimuth divided by ten is an integer value;
that the azimuths correspond to a plurality of non-overlapping sectors of coverage;
one or more allowed inter-azimuth angles associated with the azimuths; or
buffer clutter height values allowed within an angle range of each of the plurality of non-overlapping sectors.

12. A method comprising:
receiving, by one or more processing devices, a selection of a design parameter to be verified that is associated with deployment of a new radio access network (RAN) site;
retrieving a design value of the design parameter from a design data store;
retrieving one or more threshold values from design guidelines that constrain the design parameter according to site design rules; and
in response to the design value not satisfying the one or more threshold values:
determining, by the one or more processing devices, based on data associated with other RAN site deployments in an area of interest (AOI) that includes a proposed location for the new RAN site, an updated design value that satisfies the one or more threshold values; and
replacing, by the one or more processing devices in the design data store, the design value with the updated design value.

13. The method of claim 12, further comprising electronically issuing a work order or instructions to a site deployment team that incorporates a plurality of design values, including the updated design value, stored in the design data store.

14. The method of claim 12, wherein the data comprises at least one of topographical-related information retrieved from a digital map of a region that includes the AOI, existing RAN site locations, or design values of design parameters associated with the existing RAN site locations.

15. The method of claim 12, wherein the design parameter is hotspot coverage, the design value comprises locations of hotspot polygons, and the one or more threshold values comprise at least one of reserve signal receive power (RSRP) target values for RAN site locations, signal-to-interference noise ratio (SINR) target values for RAN site locations, and throughput target values for RAN site locations in the AOI.

16. The method of claim 12, wherein the design parameter is a population size, the design value is a population size value within a predetermined distance of the proposed location, and the one or more threshold values comprise average population coverage per transmitter and average population coverage based on morphology and including median, minimum, and maximum population target values.

17. A non-transitory computer-readable storage medium storing instructions, which when executed by one or more processing devices, causes the one or more processing devices to perform operations comprising:
selecting a design parameter to be verified that is associated with existing deployments of a plurality of radio access network (RAN) sites;
retrieving design values of the design parameter from a design data store;
retrieving one or more threshold values from design guidelines that constrain the design parameter according to site design rules; and
in response to a design value not satisfying the one or more threshold values for a particular RAN site of the plurality of RAN sites:
determining an updated design value that satisfies the one or more threshold values based on first data associated with RAN site deployments in an area of interest (AOI) of the plurality of RAN sites; and
replacing the design value in the design data store with the updated design value.

18. The non-transitory computer-readable storage medium of claim 17, wherein the operations further comprise, in response to a design value not satisfying the one or more threshold values for a particular RAN site of the plurality of RAN sites, electronically issuing a work order or instructions to a maintenance team to update a configuration of the particular RAN site based on the updated design value.

19. The non-transitory computer-readable storage medium of claim 17, wherein determining the updated design value also comprises determining the updated design value satisfies one or more additional threshold values based on second data associated with a RAN site located in a neighbor AOI.

20. The non-transitory computer-readable storage medium of claim 19, wherein the first data or the second data comprises at least one of topographical-related information retrieved from a digital map of a region that includes the AOI and the neighbor AOI, locations of the plurality of RAN sites, or design values of design parameters associated with the locations.

21. The non-transitory computer-readable storage medium of claim 17, wherein the design parameter is a location a radio unit (RU) of the particular RAN site, the design value is a longitude and latitude point, and the one or more threshold values comprise at least one of AOI border values or a logical distance calculation (LDC) value between the RU and a distribution unit (DU) of the particular RAN site.

22. The non-transitory computer-readable storage medium of claim 17, wherein the design parameter is an antenna height, the design value is an antenna height value that accounts for an antenna pole height in response to the antenna being on a rooftop, and the one or more threshold values comprises a set of allowed antenna heights depending on morphology.

23. The non-transitory computer-readable storage medium of claim 22, wherein the design parameter is an antenna tilt, the design value is at least one of a mechanical antenna tilt value or an electrical antenna tilt value, and the one or more threshold values comprise a set of allowed tilt ranges that depend on a combination of frequency band and the antenna height value.

24. The non-transitory computer-readable storage medium of claim 17, wherein the design parameter is antenna type, the design value corresponds to the antenna type, and the one or more threshold values comprise at least one of directional type of antenna, gain level, number of antenna elements, and antenna weight.

25. The non-transitory computer-readable storage medium of claim 17, wherein the design parameter is antenna azimuths, the design value corresponds to azimuths of each antenna, and the one or more threshold values comprise:
a number of transmitters per site allowed per frequency band; and
for antennas coupled to each transmitter, at least one of:
that each azimuth divided by ten is an integer value;
that the azimuths correspond to a plurality of non-overlapping sectors of coverage;
one or more allowed inter-azimuth angles associated with the azimuths; or
buffer clutter height values allowed within an angle range of each of the plurality of non-overlapping sectors.

26. The non-transitory computer-readable storage medium of claim 17, wherein the design parameter is a population size, the design value is a population size value within a predetermined distance of the particular RAN site, and the one or more threshold values comprise average population coverage per transmitter and average population coverage based on morphology and including median, minimum, and maximum population target values.

27. The non-transitory computer-readable storage medium of claim 17, wherein the design parameter is hotspot coverage, the design value comprises locations of hotspot polygons, and the one or more threshold values comprise at least one of reserve signal receive power (RSRP) target values for the plurality of RAN sites, signal-to-interference noise ratio (SINR) target values for the plurality of RAN sites, and throughput target values for the plurality RAN sites in the AOI.

28. The non-transitory computer-readable storage medium of claim 27, wherein the operations further comprise:
receiving, based on a first azimuth, a distance target value for a distance between a radio unit (RU) of the particular RAN site and a hotspot polygon of the hotspot polygons; and
in response to the distance between the RU and the hotspot polygon not satisfying the distance target value, determining a second azimuth that causes the distance to satisfy the distance target value to at least one of the hotspot polygons.
